(19) United States
(12) Patent Application Publication
(10) Pub. No.: US 2026/0280193 A1
(43) Pub. Date: Sep. 17, 2026

(54) COAXIAL CONNECTOR AND COAXIAL CONNECTOR UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takeyoshi OGUMA, Mie (JP); Keisuke KANEMURA, Mie (JP)

(21) Appl. No.: 19/168,808

(22) PCT Filed: Mar. 14, 2024
(86) PCT No.: PCT/JP2024/009992

§ 371 Date: Sep. 25, 2025

(30) Foreign Application Priority Data
Apr. 3, 2023 (JP) 2023-060134

(51) Int. Cl. H01R 13/642; H01R 13/58; H01R 13/627; H01R 24/20; H01R 24/28; H01R 24/40

(52) U.S. Cl. CPC H01R 13/642; H01R 13/582; H01R 13/6272; H01R 24/20; H01R 24/28; H01R 24/40

(57) ABSTRACT

The purpose of the present invention is to enable smooth connection of outer conductor terminals. This coaxial connector is a coaxial connector that includes a coaxial terminal to which a mating coaxial terminal is connected, the coaxial connector comprising a coaxial terminal that includes an inner conductor terminal and a cylindrical outer conductor terminal surrounding the inner conductor terminal, and a resin housing that includes a terminal holding part holding the coaxial terminal, wherein the coaxial terminal includes a holding subject held by the terminal holding part, and a connecting end part that protrudes from the terminal holding part and is connected to the mating coaxial terminal, and the resin housing includes a regulating cylinder part that extends from the terminal holding part to surround the connecting end part and regulates the posture of the connecting end part.

### Technical Field

The present disclosure relates to a coaxial connector and a coaxial connector unit.

### BACKGROUND

Patent Document 1 discloses a connection structure of a mating connector including a female terminal and a connector including a tab-shaped male terminal. According to a technique of Patent Document 1, a guide groove is formed in a receptacle of the connector and the inclination of the mating connector during insertion is corrected by the guide groove.

### PRIOR ART DOCUMENT

### Patent Document

Patent Document 1: JP 2019-160591 A

### SUMMARY OF THE INVENTION

### Problems to be Solved

In a coaxial connector in which a mating coaxial terminal is connected to a coaxial terminal, an outer conductor terminal is located on an outer peripheral side of an inner conductor terminal. Thus, when the coaxial terminals of the both connectors are connected, the outer conductor terminals of the both connectors possibly butt against each other and it is desired to smoothly connect the outer conductor terminals.

Accordingly, the present disclosure aims to enable outer conductor terminals to be smoothly connected.

### Means to Solve the Problem

The present disclosure is directed to a coaxial connector with a coaxial terminal to be connected to a mating coaxial terminal, the coaxial terminal including an inner conductor terminal and a tubular outer conductor terminal surrounding the inner conductor terminal, and a resin housing including a terminal holding portion for holding the coaxial terminal, the coaxial terminal including a held portion to be held by the terminal holding portion and a connection end portion projecting from the terminal holding portion, the connection end portion being connected to the mating coaxial terminal, and the resin housing including a restricting tube portion extending from the terminal holding portion to surround the connection end portion, the restricting tube portion restricting a posture of the connection end portion.

### Effect of the Invention

According to the present disclosure, outer conductor terminals can be smoothly connected.

### BRIEF DESCRIPTION OF THE DRAWINGS

FIG. 1 is a perspective view showing a connected state of a coaxial connector and a mating coaxial connector according to an embodiment.

FIG. 2 is a perspective view showing a state before the coaxial connector and the mating coaxial connector are connected.

FIG. 3 is a perspective view showing the state before the coaxial connector and the mating coaxial connector are connected.

FIG. 4 is a front view showing the coaxial connector.

FIG. 5 is a section along V-V of FIG. 2.

FIG. 6 is a section along VI-VI of FIG. 1.

FIG. 7 is a section along VII-VII of FIG. 1.

### DETAILED DESCRIPTION TO EXECUTE THE INVENTION

### Description of Embodiments of Present Disclosure

First, embodiments of the present disclosure are listed and described.

The coaxial connector of the present disclosure is as follows.
(1) The coaxial connector of the present disclosure is provided with a coaxial terminal to be connected to a mating coaxial terminal, the coaxial terminal including an inner conductor terminal and a tubular outer conductor terminal surrounding the inner conductor terminal, and a resin housing including a terminal holding portion for holding the coaxial terminal, the coaxial terminal including a held portion to be held by the terminal holding portion and a connection end portion projecting from the terminal holding portion, the connection end portion being connected to the mating coaxial terminal, and the resin housing including a restricting tube portion extending from the terminal holding portion to surround the connection end portion, the restricting tube portion restricting a posture of the connection end portion.

According to this coaxial connector, the posture of the tubular outer conductor terminal is restricted by the restricting tube portion. Thus, it is suppressed that the mating outer conductor terminal of a mating coaxial connector and the tubular outer conductor terminal butt against each other, and the mating outer conductor terminal and the tubular outer conductor terminal are smoothly connected.
(2) In the coaxial connector of (1), the restricting tube portion may include a tip edge part located further on a tip side than a tip of the connection end portion, and the tip edge part may have a tapered guiding surface extending toward inside of the tubular outer conductor terminal.

In this case, if the mating outer conductor terminal contacts the guiding surface, the mating outer conductor terminal is guided toward the inside of the tubular outer conductor terminal by the guiding surface. Thus, it is suppressed that the mating outer conductor terminal and the tubular outer conductor terminal butt against each other, and the mating outer conductor terminal and the tubular outer conductor terminal are more smoothly connected.
(3) In the coaxial connector of (2), the tip edge part may project toward an inner peripheral side further than an outer peripheral surface of the connection end portion.

In this case, the guiding surface is easily formed to spread toward the inner peripheral side further than the outer peripheral surface of the connection end portion. In this way, the mating outer conductor terminal is more reliably guided to the inside of the connection end portion. Further, the connection end portion is positioned by the tip edge part.
(4) A coaxial connector unit may be provided with the coaxial connector of (3) and a mating coaxial connector including the mating coaxial terminal, the mating coaxial terminal including an inserting portion to be inserted into the tubular outer conductor terminal and a base end portion connected to a base end side of the inserting portion via a step portion, the base end portion including a mating outer conductor terminal having a larger outer diameter than the inserting portion, and a tip of the tubular outer conductor terminal facing the step portion via the tip edge part.

The inserting portion has such a thickness as to be insertable into the tubular outer conductor terminal. Since the base end portion is thicker than the inserting portion, the thickness of the base end portion can be approximated to that of the tubular outer conductor terminal. Since the tip of the tubular outer conductor terminal is facing the step portion via the tip edge part, a part from the tubular outer conductor terminal to the mating outer conductor terminal can have as uniform a thickness as possible except in a part into which the tip edge part is inserted. In this way, a desired characteristic impedance is more easily obtained and high-speed communication performance can be improved in a connected part of the coaxial terminal and the mating coaxial terminal.
(5) In the coaxial connector of any one of (1) to (4) or the coaxial connector unit, a terminal arrangement space for arranging the mating outer conductor terminal of the mating coaxial terminal may be formed between the inner conductor terminal and the tubular outer conductor terminal.

Since the mating outer conductor terminal is arranged in the tubular outer conductor terminal, it is possibly difficult to incorporate a structure for restricting a posture on an outer peripheral side of the mating outer conductor terminal. Accordingly, by restricting the posture of the tubular outer conductor terminal by the restricting tube portion, it is suppressed that the mating outer conductor terminal and the tubular outer conductor terminal butt against each other, and the mating outer conductor terminal and the tubular outer conductor terminal are smoothly connected.
(6) In the coaxial connector of any one of (1) to (5) or the coaxial connector unit, the resin housing may include an outer wall portion surrounding the restricting tube portion while being spaced apart therefrom, and a housing arrangement space may be formed between the restricting tube portion and the outer wall portion, a mating housing surrounding the mating coaxial terminal entering the housing arrangement space.

In this way, the mating outer conductor terminal and the tubular outer conductor terminal are smoothly connected in a structure in which the resin housing and the mating housing are fit.
(7) In the coaxial connector or the coaxial connector unit of (6), the outer wall portion may include a lock portion for locking the mating housing.

By locking the lock portion of the outer wall portion of the housing to the mating housing in this way, the coaxial connector and the mating coaxial connector can be kept in a connected state.
(8) In the coaxial connector or the coaxial connector unit of (6) or (7), the outer wall portion may surround only one restricting tube portion.

In this way, the enlargement of the coaxial connector is suppressed.
(9) In the coaxial connector of any one of (1) to (8) or the coaxial connector unit, the inner conductor terminal may be a pin-like terminal, and the tubular outer conductor terminal may be a hollow cylindrical terminal coaxially arranged with respect to the inner conductor terminal.

In this case, signal transmission characteristics for high-speed communication can be improved.
(10) In the coaxial connector of any one of (1) to (9) or the coaxial connector unit, the coaxial terminal may include a cable holding portion located on a base end side of the tubular outer conductor terminal, the cable holding portion may hold an end part of a coaxial cable, and the terminal holding portion may include a holding tube portion, the cable holding portion being inserted into the holding tube portion, and a locking lance for locking the cable holding portion inserted into the holding tube portion.

The coaxial terminal is possibly inclined in a state where the cable holding portion is inserted in the holding tube portion and the locking lance is locked to the cable holding portion. In such a case, by restricting the inclination of the connection end portion in the coaxial terminal by the restricting tube portion, it is suppressed that the mating outer conductor terminal and the tubular outer conductor terminal butt against each other, and the mating outer conductor terminal and the tubular outer conductor terminal are more smoothly connected.

### Details of Embodiment of Present Disclosure

Specific examples of a coaxial connector and a coaxial connector unit of the present disclosure are described below with reference to the drawings. Note that the present disclosure is not limited to these illustrations, but is represented by claims and intended to include all changes in the scope of claims and in the meaning and scope of equivalents.

### Embodiment

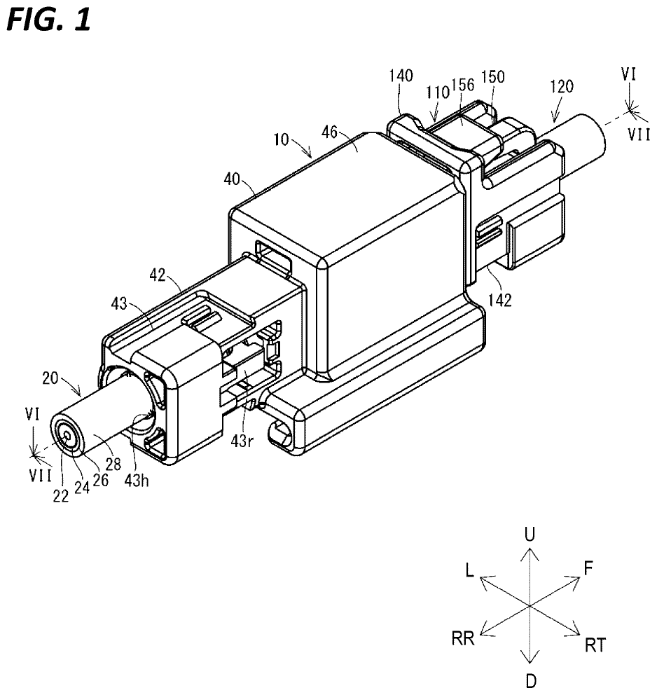

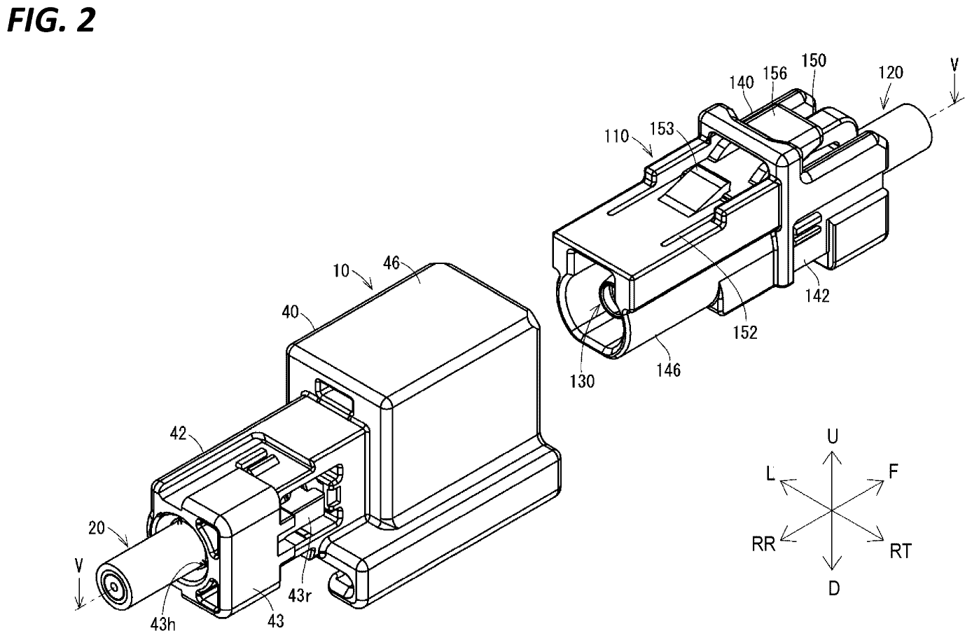

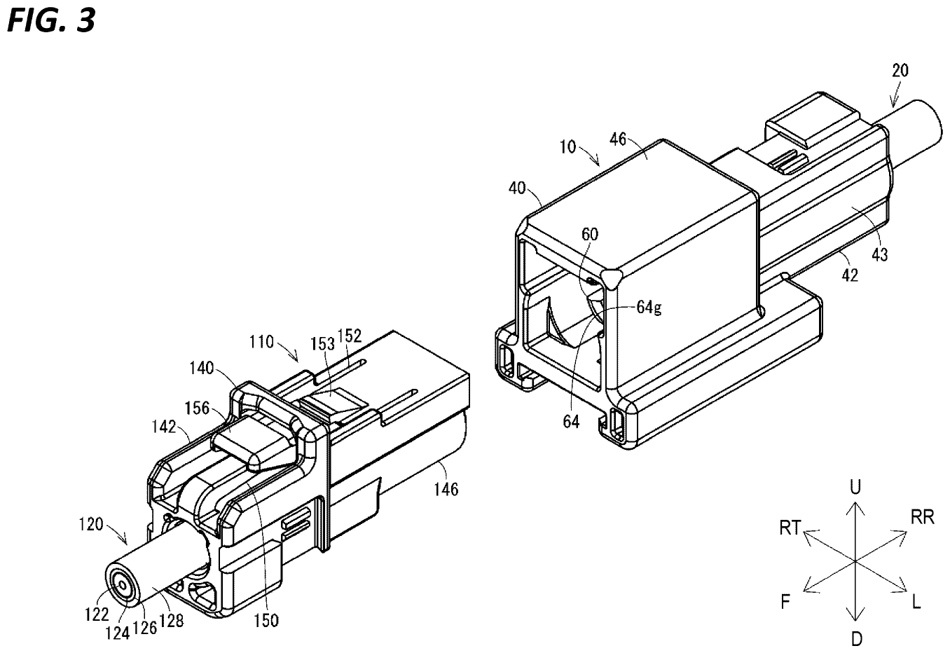

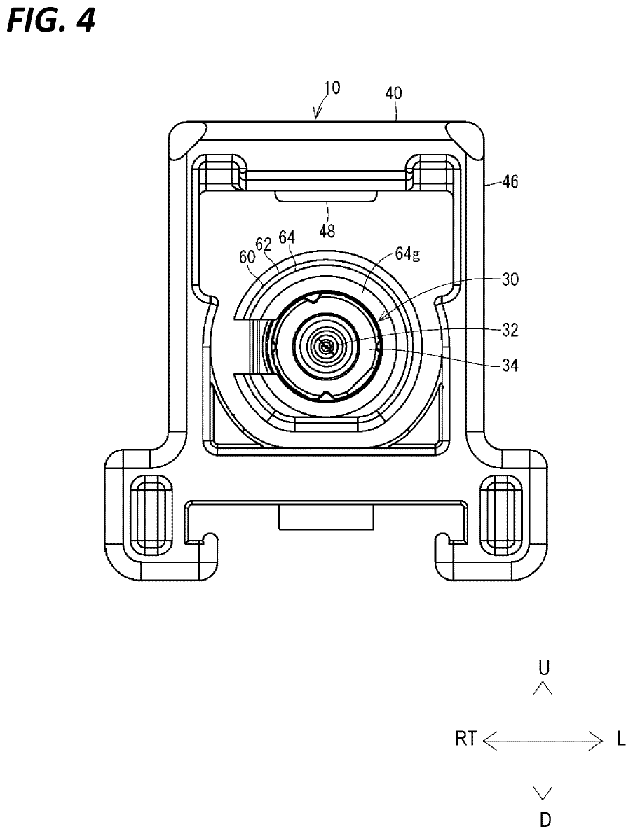

Hereinafter, a coaxial connector according to an embodiment is described. FIG. 1 is a perspective view showing a state where a mating coaxial connector 110 is connected to a coaxial connector 10. FIGS. 2 and 3 are perspective views showing a state before the mating coaxial connector 110 is connected to the coaxial connector 10. FIG. 4 is a front view showing the coaxial connector 10.

The coaxial connector 10 is provided with a coaxial terminal 30 and a housing 40. The coaxial terminal 30 is held by the housing 40.

The mating coaxial connector 110 is provided with a mating coaxial terminal 130 and a mating housing 140. The mating coaxial terminal 130 is held by the mating housing 140.

By connecting the coaxial connector 10 and the mating coaxial connector 110, a connected state of the coaxial terminal 30 and the mating coaxial terminal 130 is maintained. Here, the mating housing 140 is inserted into the housing 40 for connection. In this state, a mating lock portion 150 of the mating housing 140 locks the housing 40. In this way, a connected state of the coaxial connector 10 and the mating coaxial connector 110 is maintained. A combined unit of the coaxial connector 10 and the mating coaxial connector 110 is a coaxial connector unit.

The coaxial terminal 30 is arranged in the housing 40, and the mating coaxial terminal 130 is arranged in the mating housing 140. The coaxial terminal 30 and the mating coaxial terminal 130 are connected inside the housing 40 and the mating coaxial terminal 130 and a connected state thereof is maintained.

Further, the coaxial terminal 30 is connected to a coaxial cable 20, and the mating coaxial terminal 130 is connected to a mating coaxial cable 120.

The coaxial cable 20 is, for example, provided with a center conductor 22, an inner insulator 24, an outer conductor 26 and a sheath 28. The center conductor 22 is an inner conductor and a linear conductor formed by an electrically conductive member of copper or the like. The inner insulator 24 is a dielectric made of resin or the like and surrounds the center conductor 22. The outer conductor 26 is a conductor for surrounding the inner insulator 24 and is, for example, a braid or a metal foil. The center conductor 22 and the outer conductor 26 are coaxially arranged. The sheath 28 is an insulator made of resin for covering the outer conductor 26.

The mating coaxial cable 120 is also provided with a center conductor 122, an inner insulator 124, an outer conductor 126 and a sheath 128, similarly to the coaxial cable 20.

By connecting the coaxial terminal 30 to the mating coaxial terminal 130, the center conductor 22 of the coaxial terminal 20 and the center conductor 122 of the mating coaxial terminal 130 are electrically connected. Further, the outer conductor 26 of the coaxial cable 20 and the outer conductor 126 of the mating coaxial cable 120 are electrically connected.

Note that the connection of the coaxial terminal 30 to the coaxial cable 20 is not essential. For example, the coaxial terminal 30 may be mounted on a circuit board. Further, the connection of the mating coaxial terminal 130 to the mating coaxial cable 120 is also not essential. For example, the mating coaxial terminal 130 may be mounted on a circuit board.

In the description of this embodiment, for the sake of convenience, a side where the mating coaxial connector 110 is connected may be referred to as a front side and a side where the coaxial cable 20 extends out may be referred to as a rear side on the basis of the coaxial connector 10. Further, the side of the mating lock portion 150 may be referred to as an upper side and an opposite side thereof may be referred to as a lower side. Further, a left or right side may be referred to in a forward facing state based on the above vertical relationship.

### <Coaxial Connector>

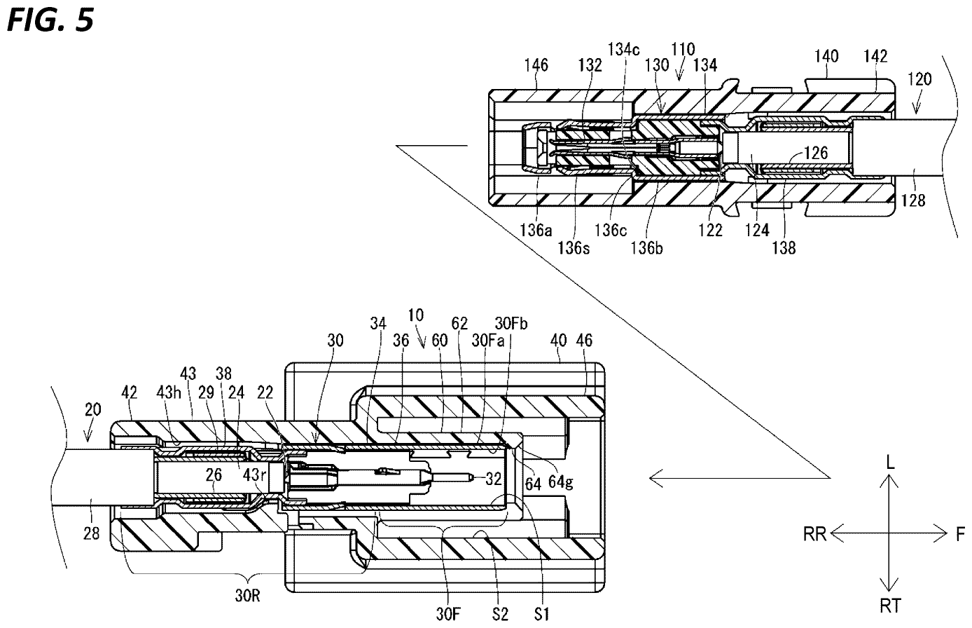

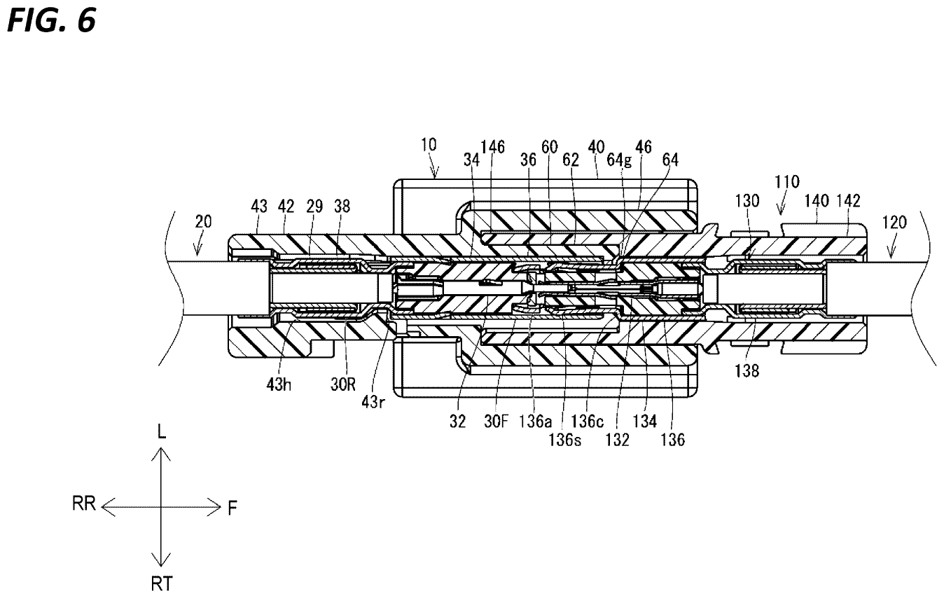

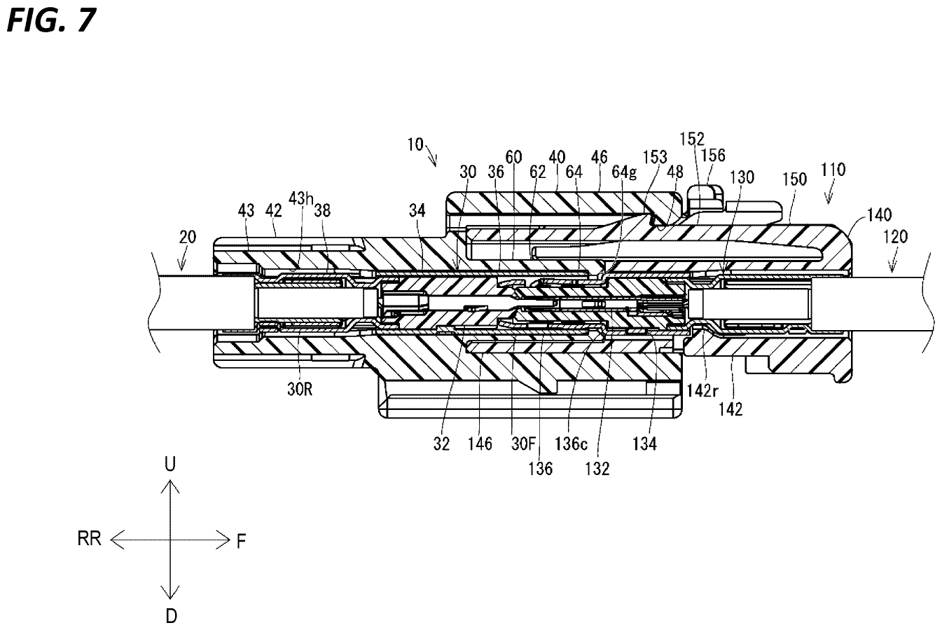

FIG. 5 is a section along V-V of FIG. 2, FIG. 6 is a section along VI-VI of FIG. 1, and FIG. 7 is a section along VII-VII of FIG. 1. As shown in FIGS. 1 to 7, the coaxial connector 10 is provided with the coaxial terminal 30 and the housing 40.

The coaxial terminal 30 is a terminal to be connected to the coaxial cable 20. The inner insulator 24 is exposed on the tip of the coaxial cable 20. The center conductor 22 projects from the tip of the exposed inner insulator 24. Further, the outer conductor 26 extends out from a tip side of the sheath 28 and covers the inner insulator 24. A metal ring 29 is mounted on the outer conductor 26 at a position before the tip of the inner insulator 24 by crimping and fixing or the like. An end part of the outer conductor 26 extending out from the metal ring 29 is folded onto the metal ring 29.

The coaxial terminal 30 includes an inner conductor terminal 32, a dielectric 34 and a tubular outer conductor terminal 36.

The inner conductor terminal 32 is formed of metal or the like into an elongated shape. In this embodiment, the inner conductor terminal 32 is a pin-like terminal. A front end part of the inner conductor terminal 32 is in the form of a bar and inserted and connected to a tubular part on the tip of a mating inner conductor terminal 132 to be described later. A rear end part of the inner conductor terminal 32 is formed into a tubular shape, and the center conductor 22 projecting on the tip of the coaxial cable 20 is inserted and connected to this tubular part. With the center conductor 22 inserted in the tubular part of the inner conductor terminal 32, the tubular part of the inner conductor terminal 32 may be crimped and fixed to the center conductor 22.

The dielectric 34 is formed of resin or the like into a cylindrical shape. A hole for accommodating the inner conductor terminal 32 is formed inside the dielectric 34. The tip of the inner conductor terminal 32 projects from the tip of the dielectric 34.

The tubular outer conductor terminal 36 is formed of metal or the like into a hollow cylindrical shape. The tubular outer conductor terminal 36 surrounds the inner conductor terminal 32. Here, the tubular outer conductor terminal 36 is coaxially arranged with respect to the inner conductor terminal 32 while covering the dielectric 34.

The front end of the tubular outer conductor terminal 36 projects further than the front end of the dielectric 34. The front end of the tubular outer conductor terminal 36 projects further than the front end of the inner conductor terminal 32. A space S1 surrounded by the inner peripheral surface of a front part of the tubular outer conductor terminal 36 and the outer peripheral surface of a front part of the center conductor 22 is formed before the front end of the dielectric inside the tubular outer conductor terminal 36. Front end parts of an outer conductor terminal 136 and a dielectric 134 of the mating coaxial terminal 130 to be described later are arranged in this space. That is, the space S1 is an example of a terminal arrangement space S1 in which at least the outer conductor terminal 136 is arranged.

In this embodiment, the tubular outer conductor terminal 36 is formed into a hollow cylindrical shape having a constant cross-sectional shape. As described later, the mating outer conductor terminal 136 to be inserted into the tubular outer conductor terminal 36 is formed with resilient contact pieces 136s.

The coaxial terminal 30 includes a cable holding portion 38 located on a base end side of the tubular outer conductor terminal 36. The cable holding portion 38 is a part for holding an end part of the coaxial cable 20. More specifically, the cable holding portion 38 is formed of metal or the like into a tubular shape. The cable holding portion 38 is externally fit around the inner insulator 24 extending from the sheath 28 in the end part of the coaxial cable 20.

A base end part of the tubular outer conductor terminal 36 is externally fit to a tip part of the cable holding portion 38 and fixed by crimping or the like. In this way, the tubular outer conductor terminal 36 and the cable holding portion 38 are kept in a connected state.

A base end part of the cable holding portion 38 is externally fit to a tip part of the sheath 28 and fixed by crimping or the like. In this way, the cable holding portion 38 holds the end part of the coaxial cable 20.

Further, an intermediate part of the cable holding portion 38 is crimped and deformed inwardly, thereby being pressed against the outer conductor 26 covering the inner insulator 24. In this way, the outer conductor 26 and the cable holding portion 38 are kept in an electrical contact state. As described above, the tubular outer conductor terminal 36 is electrically connected to the cable holding portion 38 by externally fitting the base end part of the tubular outer conductor terminal 36 to the tip part of the cable holding portion 38. Thus, the outer conductor 26 is electrically connected to the tubular outer conductor terminal 36.

The intermediate part of the cable holding portion 38 is crimped and deformed inwardly, whereby the cable holding portion 38 embraces the dielectric 34 via the outer conductor 26, the metal ring 29 and the like. Also in this way, the cable holding portion 38 holds the end part of the coaxial cable 20.

A terminal of a type in which the inner conductor terminal 32 is connected to the mating inner conductor terminal 132, like this coaxial terminal 30, may be called a male terminal. Further, the coaxial connector 10 including the male terminal may be called a male coaxial connector.

The housing 40 is a resin housing integrally molded of resin and includes a terminal holding portion 42, a restricting tube portion 60 and an outer wall portion 46.

The terminal holding portion 42 is a part for holding the coaxial terminal 30. In this embodiment, the terminal holding portion 42 includes a holding tube portion 43 and a locking lance 43r.

The holding tube portion 43 is a part, into which the cable holding portion 38 is inserted. More specifically, the holding tube portion 43 is formed into a tubular shape having a hole 43h, into which the base end part of the coaxial terminal 30, more specifically, the base end part of the tubular outer conductor terminal 36 and the cable holding portion 38, can be inserted.

The locking lance 43r is configured to be lockable to the cable holding portion 38 inserted into the holding tube portion 43. More specifically, the locking lance 43r is formed into a resiliently deformed part capable of projecting into and retracting from the inside of the hole 43h (see FIGS. 1, 2, 5 and 6). With the base end part of the coaxial terminal 30 inserted in the holding tube portion 43, the locking lance 43r is hooked to a recess of the cable holding portion 38, whereby the coaxial terminal 30 is held at a fixed position while being inserted in the terminal holding portion 42.

In this state, the tip part of the tubular outer conductor terminal 36 of the coaxial terminal 30 projects forward from the terminal holding portion 42. Out of the coaxial terminal 30, a part on a rear end side held by the terminal holding portion 42 is a held portion 30R to be held, and a part projecting from the terminal holding portion 42 and to be connected to the mating coaxial terminal 130 is a connection end portion 30F. In this embodiment, out of the coaxial terminal 30, the base end part of the tubular outer conductor terminal 36 and the cable holding portion 38 are the held portion 30R, and the remaining part of the tubular outer conductor terminal 36 is the connection end portion 30F.

The outer wall portion 46 is in the form of a tube projecting from the terminal holding portion 42, and surrounds the connection end portion 30F while being spaced apart therefrom. More specifically, the outer wall portion 46 is in the form of a rectangular tube extending forward from the front end of the terminal holding portion 42.

The inner peripheral surface of the outer wall portion 46 is formed into such a shape that an outer wall portion 146 of the mating coaxial connector 110 is fittable thereinto. The outer wall portion 146, the outer conductor terminal 136, the dielectric 134 and the inner conductor terminal 132 of the mating coaxial connector 10 are inserted inside the outer wall portion 46.

The outer wall portion 46 includes a lock portion 48 to be locked to the mating lock portion 150 of the mating housing 140. In this embodiment, the lock portion 48 is a protrusion projecting inward from the tip of the inner surface of an upper wall part of the outer wall portion 46 (see FIGS. 4 and 7). With the outer wall portion 146 of the mating coaxial connector 110 inserted in the outer wall portion 46, the mating lock portion 150 of the mating coaxial connector 110 is locked to the lock portion 48, whereby the housing 40 and the mating housing 140 are held in a retained state.

The restricting tube portion 60 is a tubular part extending forward from the terminal holding portion 42 to surround the connection end portion 30F and configured to restrict the posture of the connection end portion 30F. The posture of the connection end portion 30F can be, for example, represented by the inclination of a center axis of the connection end portion 30F with respect to a center axis of the holding tube portion 43. A center axis of the restricting tube portion 60 extends along the center axis of the holding tube portion 43. The restricting tube portion 60 restricts the posture of the connection end portion 30F such that the center axis of the connection end portion 30F extends along that of the holding tube portion 43.

More specifically, the restricting tube portion 60 includes a hollow cylindrical portion 62 projecting from the front end of the terminal holding portion 42. The inner peripheral surface of the hollow cylindrical portion 62 is formed into a circumferential surface having an inner diameter corresponding to an outer diameter of the connection end portion 30F. The inner diameter of the hollow cylindrical portion 62 may be equal to or larger than the outer diameter of the connection end portion 30F within a range that the inclination of the connection end portion 30F can be restricted to prevent the collision of the coaxial terminals 30, 130 during connection. In this embodiment, a slit is formed in a part of the outer periphery of the hollow cylindrical portion 62, but this is not essential.

The restricting tube portion 60 includes a tip edge part 64 located closer to the tip side (front side) than the tip of the connection end portion 30F. That is, the tip edge part 64 is an annular part located on the front side beyond the tip of the connection end portion 30F.

The tip edge part 64 has a tapered guiding surface 64g extending to the inside of the tubular outer conductor terminal 36. More specifically, the guiding surface 64g is an annular surface located on an inner peripheral side of the tip edge part 64 on a further front side than the restricting tube portion 60. The guiding surface 64g is formed into a tapered shape gradually reduced in diameter toward a rear side. When viewed from a center axis direction of the restricting tube portion 60, the outer peripheral edge of the guiding surface 64g is preferably located at the same position as or on an outer peripheral side of the outer peripheral surface of the connection end portion 30F.

The tip edge part 64 preferably projects toward an inner peripheral side further than an outer peripheral surface 30Fa of the connection end portion 30F. In this way, a presence region of the guiding surface 64g can be arranged inside the outer peripheral surface 30Fa of the connection end portion 30F. For example, when viewed from the center axis direction of the restricting tube portion 60, the inner peripheral edge of the guiding surface 64g can be arranged further inward than the outer peripheral surface 30Fa of the connection end portion 30F. When viewed from the center axis direction of the restricting tube portion 60, the inner peripheral edge of the guiding surface 64g is more preferably arranged at the same position as or inside an inner peripheral surface 30Fb of the 30F.

Further, if the tip edge part 64 projects toward the inner peripheral side further than the outer peripheral surface 30Fa of the connection end portion 30F, the tip of the tubular outer conductor terminal 36 can be pressed against a rearward facing surface of the tip edge part 64 when the tubular outer conductor terminal 36 is inserted into the restricting tube portion 60. In this way, the tubular outer conductor terminal 36 can be positioned with respect to the restricting tube portion 60.

The outer wall portion 46 surrounds only one restricting tube portion 60. The coaxial connector 10 may be a multi-pole coaxial connector. In this case, the outer wall portion may surround a plurality of restricting tube portions and coaxial terminals 30.

The outer wall portion 46 surrounds the restricting tube portion 60 while being spaced apart therefrom. A housing arrangement space S2, into which the mating housing 140 surrounding the mating coaxial terminal 130 is inserted, is formed between the outer wall portion 46 and the restricting tube portion 60.

### <Mating Coaxial Connector>

The mating coaxial connector 110 is described. As shown in FIGS. 1 to 3 and 5 to 7, the mating coaxial connector 110 is provided with the mating coaxial terminal 130 and the mating housing 140.

The mating coaxial terminal 130 is a terminal to be connected to the mating coaxial cable 120. The configuration of an end part of the mating coaxial cable 120 is the same as that of the coaxial cable 20.

The mating coaxial terminal 130 is provided with the inner conductor terminal 132, the dielectric 134, the outer conductor terminal 136 and a cable holding portion 138. The outer conductor terminal 136 is an example of a mating outer conductor terminal.

In terms of roles, the inner conductor terminal 132 corresponds to the inner conductor terminal 32, the dielectric 134 corresponds to the dielectric 34, the outer conductor terminal 136 corresponds to the tubular outer conductor terminal 36 and the cable holding portion 138 corresponds to the cable holding portion 38. The mating coaxial terminal 130 is described below, centered on points of difference from the coaxial terminal 30.

The inner conductor terminal 132 is formed of metal or the like into an elongated shape. One end part of the inner conductor terminal 132 is formed into a tubular shape, and the inner conductor terminal 32 is inserted and connected to this tubular part. The one end part of the inner conductor terminal 132 may be formed with a plurality of slits extending along a longitudinal direction thereof. In this case, parts between the plurality of slits, out of the one end part of the inner conductor terminal 132, can be used as spring contact points to be pressed against the outer surface of the inner conductor terminal 32.

The other end part of the inner conductor terminal 132 is formed into a tubular shape and connected to the center conductor 122 of the coaxial cable 120, similarly to the end part of the inner conductor terminal 32.

The dielectric 134 is formed of resin or the like into a cylindrical shape. A hole for accommodating the inner conductor terminal 132 is formed inside the dielectric 134. The tip of the inner conductor terminal 132 is located more inward than the tip of the dielectric 134. The inner conductor terminal 32 enters the inside of the dielectric 134 through an opening on a tip side of the hole and is inserted and connected to the one end part of the inner conductor terminal 132.

The outer conductor terminal 136 is formed of metal or the like into a tubular shape. The outer conductor terminal 136 surrounds the dielectric 134. The outer conductor terminal 136 includes an inserting portion 136a and a base end portion 136b. The inserting portion 136a is a part to be inserted into the tubular outer conductor terminal 36 of the coaxial terminal 30.

The base end portion 136b is thicker than the inserting portion 136a and connected to a base end part of the inserting portion 136a via a step portion 136c. The base end portion 136b preferably has the same thickness as the tubular outer conductor terminal 36. For example, the base end portion 136b may have the same thickness within an error range of ±20 % with respect to the tubular outer conductor terminal 36.

Note that, out of the dielectric 134, a part to be covered by the base end portion 136b is thicker than a part to be covered by the inserting portion 136a, and a step portion 134c is formed in a part where the thickness changes. The step portion 136c can contact the step portion 134c.

The inserting portion 136a includes a plurality of the resilient contact pieces 136s divided by a plurality of slits extending along an axial direction of the outer conductor terminal 136. The plurality of resilient contact pieces 136s can be resiliently deformed inward and outward of the inserting portion 136a. Utilizing resilient forces of these resilient contact pieces 136s, the inserting portion 136a contacts the inner peripheral surface of the tubular outer conductor terminal 36 while being pressed thereagainst.

In the connected state of the coaxial connectors 10, 110, the coaxial terminal 30 and the mating coaxial terminal 130 are connected. In this connected state, the tip of the tubular outer conductor terminal 36 and the step portion 136c of the mating outer conductor terminal 136 are facing each other while being spaced apart in a direction along the center axes of the coaxial terminal 30 and the mating coaxial terminal 130. The tip of the tubular outer conductor terminal 36 is facing the step portion 136c via a part projecting toward the inner peripheral side, out of the tip edge part 64.

The cable holding portion 138 is located on the base end side of the outer conductor terminal 136. The cable holding portion 138 is configured similarly to the cable holding portion 38, and holds an end part of the mating coaxial cable 120.

A terminal of a type in which the inner conductor terminal 32 is inserted into the tubular part of the inner conductor terminal 132, like this mating coaxial terminal 130, may be called a female terminal. Further, the mating coaxial connector 110 including the female terminal may be called a female coaxial connector.

The mating housing 140 is a resin housing integrally molded of resin and includes a terminal holding portion 142 and the outer wall portion 146.

The terminal holding portion 142 is a part for holding the mating coaxial terminal 130. In this embodiment, the terminal holding portion 142 includes a hole, into which the base end part of the mating coaxial terminal 130, more specifically, the base end portion 136b of the outer conductor terminal 136 and the cable holding portion 138, can be inserted. The terminal holding portion 142 includes a locking lance 143r capable of projecting into and retracting from the inside of the hole (see FIG. 7). With the base end part of the mating coaxial terminal 130 inserted in the terminal holding portion 142, the locking lance 143r is hooked to a recess of the cable holding portion 138, whereby the mating coaxial terminal 130 is held at a fixed position while being inserted in the terminal holding portion 142.

In this state, the inserting portion 136a of the mating coaxial terminal 130 projects from the terminal holding portion 142. The outer wall portion 146 is in the form of a tube projecting from the terminal holding portion 142 and surrounds the inserting portion 136a while being spaced apart therefrom. More specifically, the outer wall portion 146 is formed into such a shape that a partial rectangular tube and a partial hollow cylinder are adjacently integrated so that internal spaces thereof are continuous.

The mating housing 140 includes the mating lock portion 150 for locking the housing 40. In this embodiment, the mating lock portion 150 includes a resilient contact piece 152 extending toward the terminal holding portion 142 from a tip part of a part of the outer wall portion 146 forming the partial rectangular tube and a lock protrusion 153 projecting at a midway position in a longitudinal direction of the resilient contact piece 152. The lock protrusion 153 is formed at a position of the outer wall portion 146 to be inserted into the housing 40. The lock protrusion 153 can be locked to the lock portion 48 formed on the inner periphery of the outer wall portion 46 of the housing 40.

An operating portion 156 projects on the resilient contact piece 152. The operating portion 156 is formed at a position exposed to the outside of the housing 40. By pressing the operating portion 156 with the outer wall portion 146 inserted in the housing 40, the lock protrusion 153 can be pushed downward. In this way, the locking of the lock portion 48 to the lock protrusion 153 can be released and the mating housing 140 can be pulled out from the housing 40.

### <Concerning Connecting Operation and Connected State>

A connecting operation and the connected state of the coaxial connector 10 and the mating coaxial connector 110 are described.

When the connecting operation is started, the opening of the outer wall portion 46 of the coaxial connector 10 and that of the outer wall portion 146 of the mating coaxial connector 110 are arranged to face each other. In this state, the coaxial terminal 30 in the outer wall portion 46 and the mating coaxial terminal 130 in the outer wall portion 146 are arranged to face each other (see FIGS. 2, 3 and 5).

If the coaxial connector 10 and the mating coaxial connector 110 are brought closer, the outer wall portion 146 enters the inside of the outer wall portion 46. If the tip part of the outer wall portion 146 enters the inside of the tip part of the outer wall portion 46, the outer conductor terminal 136 of the mating coaxial terminal 130 tries to enter the inside of the tubular outer conductor terminal 36 of the coaxial terminal 30 inside the outer wall portions 46, 146.

At this time, the outer conductor terminal 136 tries to enter the inside of the tubular outer conductor terminal 36 by being guided by the housings 40, 140. Thus, if the tubular outer conductor terminal 36 is inclined with respect to the housing 40, the tip of the outer conductor terminal 136 possibly butts against that of the tubular outer conductor terminal 36.

In this embodiment, the tubular outer conductor terminal 36 is restricted to be in the fixed posture with respect to the terminal holding portion 42 by the retaining tube portion 60. More specifically, the posture of the connection end portion 30F is so restricted that the center axis of the connection end portion 30F of the tubular outer conductor terminal 36 extends along that of the terminal holding portion 42. Thus, the outer conductor terminal 136 is smoothly inserted into the tubular outer conductor terminal 36 in a predetermined posture.

Further, even if the tubular outer conductor terminal 36 is held in the predetermined posture, the tip of the outer conductor terminal 136 possibly butts against that of the tubular outer conductor terminal 36 if the outer conductor terminal 136 is inclined with respect to the mating housing 140.

In this embodiment, the tip edge part 64 of the retaining tube portion 60 has the guiding surface 64g. Thus, if the outer conductor terminal 136 is approaching the tubular outer conductor terminal 36 with a center axis of the tip of the outer conductor terminal 136 shifted with respect to that of the tip of the tubular outer conductor terminal 36, the tip of the outer conductor terminal 136 contacts the guiding surface 64g. Then, the tip of the outer conductor terminal 136 is guided toward the inner peripheral side of the guiding surface 64g, i.e. toward the inside of the tubular outer conductor terminal 36 according to the tapered shape of the guiding surface 64g. In this way, the inclination of the outer conductor terminal 136 is corrected and the butting of the tip of the outer conductor terminal 136 against that of the tubular outer conductor terminal 36 is suppressed. Then, the outer conductor terminal 136 is smoothly inserted into the tubular outer conductor terminal 36.

Particularly, if the tip edge part 64 projects further inward than the outer peripheral surface of the connection end portion 30F, the outer conductor terminal 136 is easily guided further inward than the outer peripheral surface of the connection end portion 30F.

After the tip of the outer conductor terminal 136 is inserted into the tip of the tubular outer conductor terminal 36, the mating coaxial connector 110 is further pushed toward the coaxial connector 10. Then, the inserting portion 136a, the dielectric 134 and the inner conductor terminal 132 of the mating coaxial terminal 130 are inserted into the connection end portion 30F.

Eventually, the inner conductor terminal 32 is inserted into the dielectric 134 and further inserted into the end part of the mating inner conductor terminal 132 in the dielectric 134. The coaxial terminal 30 and the mating coaxial terminal 130 are brought closer and connected until the tip of the dielectric 34 enters the inside of the tip of the inserting portion 136a to such an extent as to butt against the dielectric 134. In this connected state, the tip of the inner conductor terminal 32 is inserted into the tip of the inner conductor terminal 132, whereby the inner conductor terminals 32, 132 are electrically connected. Further, the resilient contact pieces 136s of the inserting portion 136a are pressed against the inner peripheral surface of the tubular outer conductor terminal 36, whereby the tubular outer conductor terminal 36 and the outer conductor terminal 136 are electrically connected.

Further, in the above connected state, the lock protrusion 153 of the mating lock portion 150 is retained and locked to the lock portion 48 of the outer wall portion 46 inside the outer wall portion 46. In this way, the coaxial connector 10 and the mating coaxial connector 110 are kept in the connected state.

### <Effects, Etc.>

According to the coaxial connector 10 configured as described above, the posture of the tubular outer conductor terminal 36 is restricted by the retaining tube portion 60. Thus, the inclination of the tubular outer conductor terminal 36 is suppressed and it is suppressed that the mating outer conductor terminal 136 of the mating coaxial connector 110 and the tubular outer conductor terminal 36 butt against each other. In this way, the outer conductor terminal 136 and the tubular outer conductor terminal 36 are smoothly connected.

Further, the tip edge part 64 of the retaining tube portion 60 has the tapered guiding surface 64g. Thus, if the mating outer conductor terminal 136 contacts the guiding surface 64g, this outer conductor terminal 136 is guided to the inside of the tubular outer conductor terminal 36. Thus, even if the outer conductor terminal 136 is inclined, it is suppressed that the outer conductor terminal 136 and the tubular outer conductor terminal 36 butt against each other, and the outer conductor terminal 136 and the tubular outer conductor terminal 36 are smoothly connected.

Further, since the tip edge part 64 projects toward the inner peripheral side further than the outer peripheral surface 30Fa of the connection end portion 30F, the guiding surface 64g is easily formed on the inner peripheral side of the outer peripheral surface 30Fa. In this way, the outer conductor terminal 136 is more reliably guided toward the inside of the connection end portion 30F. Further, the connection end portion 30F is positioned by pressing the tip of the connection end portion 30F against the tip edge part 64.

Further, the inserting portion 136a of the outer conductor terminal 136 is set to have such a thickness as to be insertable into the tubular outer conductor terminal 36. If the entire outer conductor terminal is formed to have the same thickness as the inserting portion 136a, there is a possibility that the thickness of the outer conductor varies in the coaxial terminals connected to each other and desired characteristic impedance performance cannot be obtained. Accordingly, the outer conductor terminal 136 includes the base end portion 136b thicker than the inserting portion 136a, whereby the thickness of the base end portion 136b can be approximated to that of the outer conductor terminal 136. Further, the base end portion 136b is thicker than the inserting portion 136a via the step portion 136c, and the tip of the tubular outer conductor terminal 36 is facing this step portion 136c via the tip edge part 64. Thus, a part from the tubular outer conductor terminal 36 to the outer conductor terminal 136 can have as uniform a thickness as possible except in a part where the tip edge part 64 is inserted. In this way, in a connected part of the coaxial terminal 30 and the mating coaxial terminal 130, characteristic impedance performance can be approximated to the desired characteristic impedance performance and high-speed communication performance can be improved.

Further, since the outer conductor terminal 136 is configured to be arranged in the tubular outer conductor terminal 36, it is possibly difficult to incorporate a structure for restricting the posture of the outer conductor terminal 136 on an outer peripheral side of the outer conductor terminal 136. Accordingly, by restricting the posture of the tubular outer conductor terminal 36 by the restricting tube portion 60, it is suppressed that the outer conductor terminal 136 and the tubular outer conductor terminal 36 butt against each other.

Further, the housing arrangement space S2, into which the mating housing 140 surrounding the mating coaxial terminal 130 is inserted, is formed between the restricting tube portion 60 and the outer wall portion 46. Thus, the outer conductor terminal 136 and the tubular outer conductor terminal 36 are smoothly connected in a structure in which the housing 40 and the mating housing 140 are fit.

Further, since the outer wall portion 46 includes the lock portion 48 for locking the mating housing 140, the coaxial connectors 10, 110 can be kept in the connected state using this lock portion 48.

Further, the outer wall portion 46 surrounds only one restricting tube portion 60. Thus, the enlargement of the coaxial connector 10 is suppressed.

Further, the inner conductor terminal 32 is a pin-like terminal and the tubular outer conductor terminal 36 is a hollow cylindrical terminal coaxially arranged with respect to the inner conductor terminal 32. Thus, signal transmission characteristics for high-speed communication can be improved.

Further, the coaxial terminal 30 includes the cable holding portion 38, and the terminal holding portion 42 includes the holding tube portion 43 and the locking lance 43r. In this way, the cable holding portion 38 can be easily held by the terminal holding portion 42. In this case, the coaxial terminal 30 is possibly inclined with respect to the cable holding portion 38 with the locking lance 43r locked to the cable holding portion 38. In such a case, by restricting the inclination of the connection end portion 30F in the coaxial terminal 30, it is suppressed that the outer conductor terminal 136 and the tubular outer conductor terminal 36 butt against each other and the outer conductor terminal 136 and the tubular outer conductor terminal 36 are smoothly connected.

Note that the coaxial connector 10 may be a multi-pole coaxial connector including a plurality of coaxial terminals 30. In this case, an outer wall portion may collectively surround the plurality of coaxial terminals or may separately surround the plurality of coaxial terminals.

Further, the restricting tube portion 60 may not have a function of restricting the posture of the tubular outer conductor terminal 36 and may have a guiding function by the guiding surface 64g.

Note that the respective configurations described in the above embodiment and the respective modifications can be appropriately combined as long as these do not contradict each other.

### LIST OF REFERENCE NUMERALS

10 coaxial connector
20 coaxial cable
22, 122 center conductor
24, 124 inner insulator
26, 126 outer conductor
28, 128 sheath
29 metal ring
30 coaxial terminal
30F connection end portion
30Fa outer peripheral surface
30Fb inner peripheral surface
30R held portion
32, 132 inner conductor terminal (pin-like terminal)
34, 134 dielectric
36 tubular outer conductor terminal (hollow cylindrical terminal)
38, 138 cable holding portion
40 housing (resin housing)
42,142 terminal holding portion
43 holding tube portion
43h hole
43r, 143r locking lance
46,146 outer wall portion
48 lock portion
60 restricting tube portion
62 hollow cylindrical portion
64 tip edge part
64g guiding surface
110 mating coaxial connector
120 mating coaxial cable
130 mating coaxial terminal
134c step portion
136 outer conductor terminal (mating outer conductor terminal)
136a inserting portion
136b base end portion
136c step portion
136s resilient contact piece
140 mating housing
150 mating lock portion
152 resilient piece
153 lock protrusion
156 operating portion
S1 terminal arrangement space
S2 housing arrangement space

1. A coaxial connector, comprising:
a coaxial terminal to be connected to a mating coaxial terminal, the coaxial terminal including an inner conductor terminal and a tubular outer conductor terminal surrounding the inner conductor terminal; and
a resin housing including a terminal holding portion for holding the coaxial terminal,
the coaxial terminal including a held portion to be held by the terminal holding portion and a connection end portion projecting from the terminal holding portion, the connection end portion being connected to the mating coaxial terminal, and
the resin housing including a restricting tube portion extending from the terminal holding portion to surround the connection end portion, the restricting tube portion restricting a posture of the connection end portion.

2. The coaxial connector of claim 1, wherein:
the restricting tube portion includes a tip edge part located further on a tip side than a tip of the connection end portion, and
the tip edge part has a tapered guiding surface extending toward inside of the tubular outer conductor terminal.

3. The coaxial connector of claim 2, wherein the tip edge part projects toward an inner peripheral side further than an outer peripheral surface of the connection end portion.

4. A coaxial connector unit, comprising:
the coaxial connector of claim 3; and
a mating coaxial connector including the mating coaxial terminal,
the mating coaxial terminal including an inserting portion to be inserted into the tubular outer conductor terminal and a base end portion connected to a base end side of the inserting portion via a step portion, the base end portion including a mating outer conductor terminal having a larger outer diameter than the inserting portion, and
a tip of the tubular outer conductor terminal facing the step portion via the tip edge part.

5. The coaxial connector of claim 1, wherein a terminal arrangement space for arranging a mating outer conductor terminal of the mating coaxial terminal is formed between the inner conductor terminal and the tubular outer conductor terminal.

6. The coaxial connector of claim 1, wherein:
the resin housing includes an outer wall portion surrounding the restricting tube portion while being spaced apart therefrom, and
a housing arrangement space is formed between the restricting tube portion and the outer wall portion, a mating housing surrounding the mating coaxial terminal entering the housing arrangement space.

7. The coaxial connector of claim 6, wherein the outer wall portion includes a lock portion for locking the mating housing.

8. The coaxial connector of claim 6, wherein the outer wall portion surrounds only one restricting tube portion.

9. The coaxial connector of claim 1, wherein:
the inner conductor terminal is a pin-like terminal, and the tubular outer conductor terminal is a hollow cylindrical terminal coaxially arranged with respect to the inner conductor terminal.

10. The coaxial connector of claim 1, wherein:
the coaxial terminal includes a cable holding portion located on a base end side of the tubular outer conductor terminal,
the cable holding portion holds an end part of a coaxial cable, and
the terminal holding portion includes a holding tube portion, the cable holding portion being inserted into the holding tube portion, and a locking lance for locking the cable holding portion inserted into the holding tube portion.
